(19) United States
(12) Patent Application Publication
(10) Pub. No.: US 2026/0046739 A1
(43) Pub. Date: Feb. 12, 2026

(54) METHODS AND APPARATUS FOR HANDLING SUBSEQUENT CPAC IN A WIRELESS COMMUNICATION SYSTEM

(71) Applicant: Samsung Electronics Co., Ltd., Gyeonggi-do (KR)

(72) Inventor: Aby Kanneath ABRAHAM, Bengaluru (IN)

(21) Appl. No.: 19/291,110

(22) Filed: Aug. 5, 2025

(30) Foreign Application Priority Data
Aug. 6, 2024 (IN) 202441059435
Jul. 23, 2025 (IN) 202441059435

(51) Int. Cl. H04W 36/36; H04L 41/5067; H04W 12/106; H04W 76/20

(52) U.S. Cl. CPC H04W 36/362; H04L 41/5067; H04W 12/106; H04W 76/20

(57) ABSTRACT

The disclosure relates to a 5G or 6G communication system for supporting higher data transmission rates and satisfying various service requirements. A method performed by a terminal in a wireless communication system includes receiving, from a base station, a first RRC reconfiguration message including at least one candidate configuration for a subsequent CPAC, storing the at least one candidate configuration for the subsequent CPAC; selecting a configuration from the at least one candidate configuration for the subsequent CPAC for an execution of the subsequent CPAC, the configuration being not stored in an SCG variable for storing conditional reconfiguration; determining whether a radio bearer configured in the terminal is an SRB 5 and an sk-counter value is updated due to the execution of the subsequent CPAC; and in case that the radio bearer is the SRB 5 and the sk-counter value is updated due to the execution of the subsequent CPAC, triggering a PDCP entity of the SRB 5 to perform a PDCP re-establishment.

### CROSS-REFERENCE TO RELATED APPLICATION(S)

This application is based on and claims priority under 35 U.S.C. § 119 to Indian Provisional Patent Application No. 202441059435, which was filed in the Indian Patent Office on Aug. 6, 2024, and to Indian Non-Provisional Patent Application No. 202441059435, which was filed in the Indian Patent Office on Jul. 23, 2025, the entire disclosure of each of which is incorporated herein by reference.

### 1. FIELD

The disclosure relates generally to wireless communication, and more particularly, to methods and apparatus for handling subsequent conditional primary secondary cell (PSCell) addition or change (CPAC) in a wireless communication system.

### 2. DESCRIPTION OF RELATED ART

5^{th} generation (5G) mobile communication technology defines a wide frequency band to enable fast transmission speeds and new services, and can be implemented in a sub-6 gigahertz (GHz) frequency band such as 3.5 GHz, and in an ultra-high frequency band, which may be referred to as millimeter wave (mmWave) bands, such as 28 GHz and 39 GHz (above 6 GHz) bands.

In 6^{th} generation (6G) mobile communication technology, which may be referred to as beyond 5G, it is expected that securing new frequency resources such as the sub-6 GHz band, ultra-high frequency bands, and upper mid band (7-24 GHz) will be important to handle the rapidly increasing data traffic due to the spread of artificial intelligence (AI) technology and increasing streaming services, to improve user perceived performance, and to efficiently utilize all available frequency resources as needed. To this end, reallocation, reuse, or sharing of existing frequency bands from 2^{nd} generation (2G) to 5G can be considered for 6G.

Since the introduction of 5G, the communications market has been increasingly interested in improving system operation efficiency, sustainability, and user experience. Accordingly, in addition to improving traditional communications performance such as data transmission speed and delay time, the introduction of new innovative technologies such as AI, reducing operating costs, improving energy efficiency, expanding service coverage, and introducing new services are becoming increasingly important.

Since the early stages of 5G mobile communication technology, a goal has been to support services and satisfy performance requirements for enhanced mobile broadband (eMBB), ultra-reliable low-latency communications (URLLC), and massive machine-type communications (mMTC), including beamforming and massive multiple-input multiple-output (MIMO) to mitigate path loss of radio waves in ultra-high frequency bands and increase the range of radio transmission, support for various numerologies (such as operation of multiple subcarrier intervals) and dynamic operation of slot formats for efficient use of ultra-high frequency resources, initial access technology to support multi-beam transmission and wideband, definition and operation of band-width part (BWP), new channel coding methods such as low density parity check (LDPC) codes for large-capacity data transmission and polar codes for reliable transmission of control information, layer 2 (L2) pre-processing, and networks that provide dedicated networks specialized for specific services. Additionally, standardization of slicing (network slicing), etc., has been progressing.

Discussions have also been held on improving and enhancing the initial 5G mobile communication technology in consideration of the services that 5G mobile communication technology was intended to support, including vehicle-to-everything (V2X) to help autonomous vehicles make decisions based on their own location and status information transmitted by the vehicle and to increase user convenience, new radio unlicensed (NR-U) for system operation that meets various regulatory requirements in unlicensed bands, new radio (NR) terminal low power consumption technology (i.e., UE power saving), non-terrestrial network (NTN), which is direct terminal-satellite communication to secure coverage in areas where communication with terrestrial networks is impossible, positioning, NR support up to 71 GHz, support of reduced capability NR devices for lower cost and complexity compared to general terminals, user equipment (UE) power saving enhancement for improved power management in preparation for the use of various terminal types, and sidelink (SL). Standardization of the physical layer has been performed for technologies such as SL enhancement, duplex enhancements which study a new form of duplexing called subband non-overlapping full duplex (SBFD), network energy saving which secures the idle period in which the base station operates in maximum power saving mode to the maximum extent and reduces power consumption, and network controlled repeaters which have improved performance compared to existing repeaters by having the function of receiving and processing side control information from the network.

In addition, standardization of the wireless interface architecture/protocol layer for technologies such as the industrial Internet of things (IIoT) for supporting new services through linkage and convergence with other industries, integrated access and backhaul (IAB) that provides nodes for expanding network service areas by integrating wireless backhaul links and access links, mobility enhancement technology including conditional handover (CHO) and dual active protocol stack (DAPS) handover, 2-step random access channel (RACH) for NR that simplifies random access procedures, multicast and broadcast, standardization of support for multi universal subscriber identity module (USIM) devices that provide services to users using information of two or more subscriber identity modules (SIMs), SL relay that provides relay-related functions to support connections between terminals in long distances and between terminals and networks, small data transfer (SDT) which transmits small data or signaling in an inactive state without transitioning to a connected state, mobility enhancements including layer 1 (L1)/L2 triggered mobility (LTM)/subsequent conditional PSCell addition/change (SCPAC)/and CHO with candidate secondary cell groups (SCGs), extended reality (XR) enhancement to support XR services in NR systems, etc., has also been performed, and standardization of system architecture/services such as 5G baseline architecture (e.g., service-based architecture, service-based interface) for grafting network functions virtualization (NFV) and software-defined networking (SDN) technologies, mobile edge computing (MEC) that provides services based on the location of the terminal, non-public networks (NPNs) that can be used only by some permitted terminals for non-public purposes, disaster roaming that supports the use of communication services through other carriers' networks in the event of a communication disaster, proximity-based service via 5GS, and unmanned standardization has also been made in the system architecture/service areas, including support of an unmanned aircraft system (UAS) to support remote identification, tracking, and authorization of uncrewed aerial vehicles (UAVs), structural enhancements to support XR and interactive media services, 5GS to support Al/machine learning (ML) services, and advanced MEC to provide edge computing services in roaming networks, etc. has also been performed.

Currently, standardization is in progress for technologies such as beam prediction using AI/ML technology, channel state information (CSI) prediction to improve positioning accuracy, ultra-low-power terminal technology using low-power wake-up receivers, technology for transmitting long term evolution (LTE) broadcasts to 5G networks, MIMO transmission technology using multiple base stations, and ultra-low-power terminals (e.g., ambient IoT) that transmit data by obtaining power from an external source without a battery.

At the radio interface architecture/protocol layer, standardization is in progress for technologies such as LTM scenario support and conditional LTM support between central units (CUs), simultaneous support for the same XR service between multiple devices, NTN coverage enhancement and evolution, AI/ML-based mobility support, and terminal-to-terminal connection relay across multiple hops between terminals and networks.

In addition, standardization of system architecture/service fields for satellite communication optimization methods, 5G system energy usage management and efficiency, SBI-based user plane evolution, ambient IoT technology, data service provision methods in Internet protocol (IP) multimedia subsystem (IMS), and avatar communication service persists. When such 5G mobile communication systems are commercialized, a vast increase in devices connected to the communication network will be realized, and accordingly, it is expected that the functions and performance of 5G mobile communication systems will be strengthened and integrated operation of connected devices will be required. To this end, new research will be additionally conducted on XR to efficiently support augmented reality (AR), virtual reality (VR), and mixed reality (MR), 5G performance improvement and complexity reduction using AI/ML, AI service support, metaverse service support, and drone communication.

The development of these 5G mobile communication systems is expected to serve as a basis for enhancing 5G performance and ultimately evolving into 6G. In the 6G era, eMBB, URLLC, and mMTC services are expected to evolve into immersive communication (IC), hyper-reliable and low-latency communication (HRLLC), and massive communication (MC) services, respectively. In addition, new services such as AI and communication, integrated sensing and communication, and ubiquitous connectivity are expected to be additionally supported. For these 6G services, improved performance requirements compared to 5G are also essential, and standardization to define these is also in progress.

In this manner, to satisfy the expanded services and improved performance requirements of 6G, it is expected that it will be beneficial to optimize and improve system operation, such as introducing AI technology, improving energy efficiency, expanding coverage, and applying next-generation security technology, as well as developing sustainable communication technology, in addition to simply improving existing communication performance.

To this end, the latest AI technology is applied to all areas from the communication system design stage to development, management, and operation to improve communication performance and realize AI internalization technology that realizes network automation and efficiency, technology that improves user-perceived performance and network operation efficiency by improving power consumption of networks and terminals, technology that reduces power consumption in core base station components such as radio frequency (RF) and modems and in the channel coding and signal modulation and transmission/reception processes, multi-antenna transmission technology (e.g., extreme MIMO (X-MIMO)) that utilizes large antennas to overcome propagation path loss due to high frequency compared to the 3.5 GHz band of 5G communication and provide equivalent coverage, transmission/reception technology based on multiple base stations (e.g., distributed MIMO (D-MIMO)) to improve quality in cell edge areas, full-duplex communication (e.g., SBFD) technology to improve frequency efficiency and system network, next-generation encryption technology (e.g., post quantum cryptography (PQC)) and zero trust architecture (ZTA) technology to strengthen 6G communication security, and initial access delay and mobility. Research will be focused on technologies to minimize delay, design a hardware-friendly protocol structure for ultra-high-speed data processing, and expand the application of integrity protection technologies.

In addition, research will be conducted on the structure of mobile communication systems (prevention of redundant functions, simplification of functions, etc.), introduction of new planes for providing service providers, user privacy protection measures, realistic services, enhancement of network resiliency, network sharing technologies, improved security technologies (false base stations, lower layer protection, etc.), and intent-based network operation and management.

To improve mobility robustness and optimize PSCell change operations in dual connectivity (DC) scenarios, the CPAC framework has been introduced. To support and optimize the execution of CPAC, functionalities such as successful PSCell change reporting, mobility history tracking, and quality of experience (QoE) measurement reporting are also employed alongside DC.

### SUMMARY

The disclosure has been made to address the above-mentioned problems and disadvantages, and to provide at least the advantages described below.

Accordingly, an aspect of the disclosure is to provide a method and apparatus for handling signaling radio bearer (SRB) 5 configuration during subsequent CPAC.

Another aspect of the disclosure is to provide a method and an apparatus for providing information associated with a self-optimizing network for subsequent CPAC.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, a first RRC reconfiguration message including at least one candidate configuration for a subsequent CPAC; storing the at least one candidate configuration for the subsequent CPAC; selecting a configuration from the at least one candidate configuration for the subsequent CPAC for an execution of the subsequent CPAC, the configuration being not stored in an SCG variable for storing conditional reconfiguration; determining whether a radio bearer configured in the terminal is an SRB 5 and an sk-counter value is updated due to the execution of the subsequent CPAC; and in case that the radio bearer is the SRB 5 and the sk-counter value is updated due to the execution of the subsequent CPAC, triggering a packet data convergence protocol (PDCP) entity of the SRB 5 to perform a PDCP re-establishment.

In accordance with another aspect of the disclosure, a terminal in a wireless communication system is provided. The terminal includes a transceiver; a processor communicatively coupled to the transceiver; and memory, communicatively coupled to the processor, storing instructions executable by the processor to cause the terminal to: receive, from a base station, a first RRC reconfiguration message including at least one candidate configuration for a subsequent CPAC, store the at least one candidate configuration for the subsequent CPAC, select a configuration from the at least one candidate configuration for the subsequent CPAC for an execution of the subsequent CPAC, the configuration being not stored in an SCG variable for storing conditional reconfiguration, determine whether a radio bearer configured in the terminal is an SRB 5 and an sk-counter value is updated due to the execution of the subsequent CPAC, and in case that the radio bearer is the SRB 5 and the sk-counter value is updated due to the execution of the subsequent CPAC, trigger a PDCP entity of the SRB 5 to perform a PDCP re-establishment.

According to an embodiment of the disclosure, the terminal and the network may ensure secure and reliable execution of subsequent CPAC procedures by maintaining the integrity and ciphering configurations of SRBs.

In addition, according to an embodiment of the disclosure, the terminal may optimize protocol entity handling during conditional reconfiguration, including automatic re-establishment of PDCP and radio link control (RLC) entities when security keys are updated.

Furthermore, according to an embodiment of the disclosure, the terminal may manage application layer measurement configurations efficiently during CPAC execution, including consistent release and suppression of obsolete reporting mechanisms.

The effects obtainable in the disclosure are not limited to the above-mentioned effects, and other effects not mentioned herein will be clearly understood from the following description by those skilled in the art to which the disclosure belongs.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a UE for handling subsequent CPAC in a wireless communication system according to an embodiment;

FIG. 2 is a flowchart illustrating a method for handling subsequent CPAC in a wireless communication system according to an embodiment;

FIG. 3 is a flowchart illustrating a scenario of a UE RRC handling application layer measurement configuration according to an embodiment;

FIG. 4 is a flowchart illustrating a scenario of a UE RRC handling application layer measurement configuration according to an embodiment; and

FIG. 5 is a flowchart illustrating an example scenario in which a UE logs and reports a time difference between successive conditional configuration updates, according to an embodiment.

### DETAILED DESCRIPTION

Hereinafter, various embodiments of the disclosure are described in detail with reference to the accompanying drawings.

In the drawings, the same or similar elements may be denoted by the same or similar reference numerals. Some components are exaggerated, omitted, or schematically illustrated in the accompanying drawings. The size of each component does not fully reflect the actual size.

Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Also, the various embodiments described herein are not necessarily mutually exclusive, as some embodiments can be combined with one or more other embodiments to form new embodiments.

The term “or” as used herein, refers to a non-exclusive or, unless otherwise indicated.

The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits (ICs), microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings facilitate understanding of various technical features. The embodiments are not limited by these drawings and extend to any alterations, equivalents, and substitutes. Terms like first, second, etc., are used for distinction and do not limit the elements.

Third Generation Partnership Project (3GPP) specifications, such as TS 37.340 (version 17.1), define a technique known as DC, more specifically referred to as multi-radio DC (MR-DC). MR-DC allows a UE in an RRC connected state to utilize radio resources provided by two distinct schedulers located in two different next generation radio access network (NG-RAN) nodes. These nodes are connected via a non-ideal backhaul, with one node providing NR access and the other providing either evolved universal terrestrial radio access (E-UTRA) or NR access. In general, the nodes connected via non-ideal backhaul can provide radio access based on any radio access technology (RAT).

In this arrangement, one of the NG-RAN nodes (or nodes belonging to any RATs) functions as a master node (MN) and the other as a secondary node (SN). The MN and SN communicate via a network interface, and at least the MN is connected to a core network. Two exemplary configurations supported in NG-RAN include NG-RAN E-UTRA-NR DC (NGEN-DC), where the UE is connected to a next-generation evolved node B (ng-eNB) as the MN and a gNB as the SN, and NR-E-UTRA DC (NE-DC), where the UE is connected to a gNB as the MN and an ng-eNB as the SN.

The addition of an SN is initiated by the MN and establishes a UE context at the SN to enable the provision of resources from the SN to the UE. The addition of a PSCell may occur during this SN addition procedure. A conditional PSCell addition (CPA) is defined as a PSCell addition performed by the UE upon satisfaction of one or more execution conditions. Upon receiving a CPA configuration, the UE begins evaluating the specified execution condition(s) and terminates such evaluation once a PSCell addition or a primary cell (PCell) change is triggered.

The PSCell may also be changed either directly via an RRC reconfiguration message from the network or through a conditional PSCell change (CPC). The CPC is similarly executed by the UE upon satisfaction of associated execution condition(s), with evaluation beginning upon receipt of the CPC configuration and terminating once a PSCell change or PCell change occurs.

Furthermore, an SCPAC refers to a conditional PSCell addition or change procedure performed following a PSCell addition, PSCell change, PCell change, or SCG release. This procedure is based on a pre-configured subsequent CPAC configuration that includes one or more candidate PSCells. Such subsequent CPAC procedures are executed without the need for reconfiguration or re-initiation of the CPA or CPC procedures. The UE retains the subsequent CPAC configuration unless explicitly instructed by the network to release it and continues evaluating the execution conditions for the candidate PSCells after completion of the previous change event.

Both intra-SN and inter-SN subsequent CPAC procedures are supported, where the inter-SN CPAC may be initiated by either the MN or the SN. UE stores the received subsequent CPAC configuration in either master cell group (MCG) variables or SCG variables such as MCG VarConditionalReconfig or SCG VarConditionalReconfig. For example, inter-SN SCPAC configuration may be typically stored in MCG VarConditionalReconfig, while Intra-SN SCPAC configuration may be stored in SCG VarConditionalReconfig when there is no MN involvement and may be stored in MCG VarConditionalReconfig when there is MN involvement. If there is some Inter-SN SCPAC configuration and some Intra-SNS SCPAC configuration, all the configuration may be stored in MCG VarConditionalReconfig.

In DC, such as NR-DC, the UE may receive two independent conditionalReconfiguration:
a conditionalReconfiguration associated with MCG, that is included in the RRCReconfiguration message received via SRB1; and
a conditionalReconfiguration, associated with SCG, that is included in the RRCReconfiguration message received via SRB3, or, alternatively, included within a RRCReconfiguration message embedded in a RRCReconfiguration message received via SRB1.

The conditionalReconfiguration, associated with SCG may be stored in SCG VarConditionalReconfig and conditionalReconfiguration, associated with MCG may be stored in MCG VarConditionalReconfig

However, several challenges and issues arise from the current implementation of MR-DC as defined in the 3GPP specifications. One problem is the complexity involved in managing and coordinating the resources between the MN and SN, especially when they are connected via a non-ideal backhaul. This complexity can lead to increased latency and reduced efficiency in resource utilization.

Additionally, the conditional procedures such as CPA, CPC, and subsequent CPAC add layers of complexity to the UE's operations. The UE should continuously evaluate execution conditions for these procedures, which can lead to increased power consumption and processing overhead. Furthermore, the need to retain and manage multiple configurations for conditional procedures can complicate the UE's internal state management, potentially leading to errors or suboptimal performance.

The inter-SN CPAC procedures, while providing flexibility, also introduce additional signaling overhead and coordination challenges between the MN and SN. This can result in increased latency and potential synchronization issues, impacting the overall user experience.

Thus, it is desired to address the above-mentioned disadvantages, issues, or other shortcomings or at least provide a useful alternative.

In addition to the DC and the CPAC framework, certain supporting functionalities assist in optimizing and evaluating CPAC execution. These include successful PSCell addition/change reporting, mobility history tracking, and QoE measurement configuration and reporting mechanisms.

Successful PSCell Addition/Change Report (SPR) is collected by a UE for analysis of successful PSCell addition/change. Based on the configuration received from the network, the UE gathers the SPR (such as successPSCell-Report in NR) and makes it available to the network as specified in TS 38.331. The UE stores the SPR until it is fetched by the network or for 48 hours after recording. Conditions for logging SPR include a T310 threshold (thresholdPercentageT310-SCG in NR), which indicates the threshold for the ratio in percentage between the elapsed T310 timer and the configured value of the T310 timer. Detailed behavior can be found in 3GPP specifications such as TS 38.331.

A T312 threshold (thresholdPercentageT312-SCG in NR) field indicates the threshold for the ratio in percentage between the elapsed T312 timer and the configured value of the T312 timer. Detailed behavior can be found in 3GPP specifications such as TS 38.331. Similarly, a T304 threshold (thresholdPercentageT304 in NR) field indicates the threshold for the ratio in percentage between the elapsed T304 timer and the configured value of the T304 timer. Detailed behavior may be found in 3GPP specifications such as TS 38.331.

The T310 threshold, T312 threshold, and T304 threshold for SPR are applicable for the subsequent CPAC as well. The UE logs SPR if the ratio in percentage between the elapsed T310 timer/T312 timer/T304 timer and the configured value of the T310 timer/T312 timer/T304 timer is greater than the 7, 5, 10, 15, 20, 25 T310 threshold, T312 threshold, and T304 threshold configured for SPR during the subsequent CPAC.

In an embodiment, the UE maintains mobility history information, which includes the list of PCells and corresponding secondary cells (i.e., PSCells) associated with those PCells. The UE may also log the time spent in an activated state and/or the percentage of time spent in a deactivated state for each PSCell as part of the mobility history records. Further, the source NG-RAN node collects and stores the UE history information for as long as the UE stays in one of its cells. When information should be discarded because the list is full, such information may be discarded in order of its position in the list, starting with the oldest cell record. If the list is full and the UE history information from the UE is available, the UE history information from the UE is also discarded. The UE may store the time spent in a cell and the time spent without a PSCell for a PCell in the mobility history information.

QoE measurement collection (QMC) is activated in the wireless network nodes such as next-generation NodeB (gNB) either by direct configuration from operations administration and maintenance (OAM) system (management-based activation) or by signaling from the OAM via the 5G core (5GC) (signaling-based activation) containing UE-associated QoE configuration. One or more QoE measurement collection configurations can be activated at the UE per service type, and each QoE measurement configuration is uniquely identified by a QoE reference.

For signaling-based QoE measurements, the OAM initiates the QMC activation for the specific UE, via the 5GC, and the gNB receives one or more QoE measurement configurations by means of UE-associated signaling. The QoE measurement configuration for signaling-based QMC activation includes an application layer measurement configuration list and the corresponding information for QoE measurement collection, e.g., QoE reference, service type, management control entity (MCE) IP address, slice scope, area scope, minimization of drive tests (MDT) alignment information, the indication of available radio access network (RAN) visible QoE metrics, and assistance information.

The application layer measurement configuration received by the gNB from the OAM or from the 5GC is encapsulated in a transparent container, which is forwarded to the UE as measConfigAppLayerContainer in the RRC reconfiguration message (e.g., there can be multiple configurations in the same message). The application layer measurement reports received from the UE's application layer are encapsulated in a transparent container and sent to the network in the MeasurementReportAppLayer message as specified in TS 38.331. \

The UE may send multiple application layer measurement reports to the gNB in one MeasurementReportAppLayer message. To allow the transmission of application layer measurement reports that exceed the maximum PDCP service data unit (SDU) size, segmentation of the MeasurementReportAppLayer message may be enabled by the gNB.

The measurement configuration application layer identifier (ID) conveyed in the RRC signaling is used to identify the application layer measurement configuration and report between the gNB and the UE. The measurement configuration application layer ID is mapped to the QoE reference in the gNB, and the gNB forwards the application layer measurement report to the MCE together with the QoE reference. The gNB can release one or multiple application layer measurement configurations from the UE in one RRC reconfiguration message at any time.

Additionally, the UE may be configured by the gNB to indicate to the gNB when a QoE measurement session starts or stops for a certain application layer measurement configuration. The gNB may include the application layer measurement configuration in SCPAC candidate cell configuration and SCPAC reference configuration. QoE measurements can be directly sent to the SN over SRB5. The UE may be also configured with other SRBs such as SRB1, SRB2, SRB3, SRB4, etc., for different purposes, while it is configured with SRB5.

The 3GPP specification defines the SCPAC procedure; however, certain implementation aspects remain open. Specifically, it is unclear how a UE should handle SRB5 reconfiguration, the QoE measurement configurations that are not included in the applied SCPAC reconfiguration, and reporting behavior for a self-organizing network (SON) or MDT following SCPAC execution. These gaps may lead to inconsistent handling of security reporting and measurement configurations across UEs.

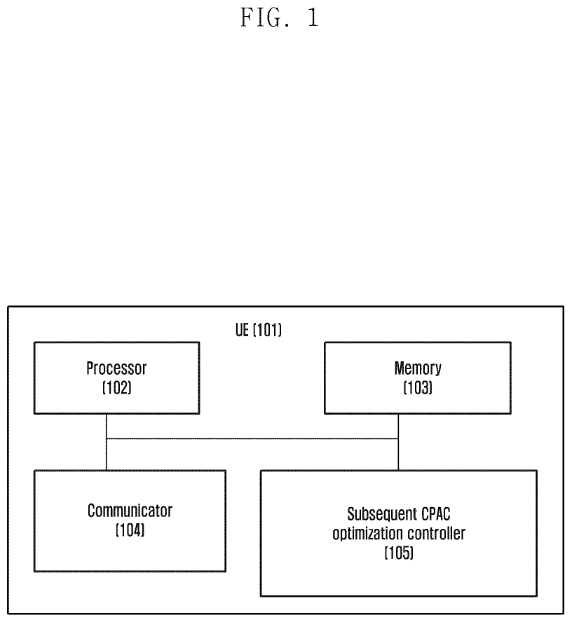

FIG. 1 illustrates a UE for handling subsequent CPAC in a communication network system, according to an embodiment.

Referring to FIG. 1, examples of the UE 101 may include consumer electronics (such as mobile phones and smartphones), tablets, wearable devices, television, computing devices (such as laptops, notebooks, desktops, workstations, etc.), IoT devices, automotive systems (such as connected cars, autonomous vehicles, V2X communication devices, etc.), enterprise devices such as robotics, specialized equipment (such as medical devices, public safety devices, etc.), and media devices (such as gaming consoles, streaming devices, etc.).

The communication network system encompasses various types of networks, including but not limited to cellular networks (such as 2G, 3G, 4G, 5G, Beyond 5G (B5G)/6G, or advanced cellular networks), local area networks (LANs) (such as Wi-Fi, Li-Fi, etc.), personal area networks (PANs) (such as Bluetooth, Zigbee, Z-Wave, etc.), wide area networks (WANs) (such as satellite communication networks, long range wide area network, narrowband IoT, low-bandwidth communication for IoT, etc.), metropolitan area networks (MANs), machine-to-machine (M2M), ad hoc and mesh networks, and emerging and advanced networks.

The UE 101 includes a processor 102, a memory 103, a communicator 104, and a subsequent CPAC optimization controller 105. The processor 102 communicates with the memory 103, the communicator 104, and the subsequent CPAC optimization controller 105. Configured to execute instructions stored in the memory 103, the processor 102 performs various processes. The processor 102 can include one or a plurality of processors, such as a general-purpose processor like a central processing unit (CPU), an application processor (AP), a graphics processing unit (GPU), a visual processing unit (VPU), and/or an AI dedicated processor like a neural processing unit (NPU).

The memory 103 includes storage locations addressable through the processor 102. The memory 103 is not limited to volatile memory and/or non-volatile memory and can include one or more computer-readable storage media. Non-volatile storage elements, such as magnetic hard discs, optical discs, floppy discs, flash memories, or forms of electrically programmable memories (EPROM) or electrically erasable and programmable (EEPROM) memories, may be included. In some examples, the memory 103 may be considered a non-transitory storage medium, indicating that it is not embodied in a carrier wave or a propagated signal. However, the term non-transitory should not be interpreted to mean that the memory 103 is non-movable. The memory 103 can be configured to store larger amounts of information than volatile memory, such as random access memory (RAM) or cache.

The communicator 104 is designed for internal communication between hardware components and external devices (client devices) via one or more networks. The communicator 104 includes an electronic circuit that enables wired or wireless communication.

Coupled to the memory 103 and the processor 102, the subsequent CPAC optimization controller 105 facilitates efficient data transfer and communication between components, ensuring real-time access and processing of configuration and measurement data. Implemented as an IC in the UE 101 or network component (e.g., a gNB), the subsequent CPAC optimization controller 105 may include a multi-core architecture for dynamic management of SCPAC operations in a wireless communication system. Each core is optimized for specific tasks, such as conditional configuration evaluation, SCPAC measurement handling, and protocol layer coordination during conditional reconfiguration. The IC for SCPAC management combines analog and digital components to optimize power consumption and performance of the SCPAC control mechanism.

The analog components include a low-noise amplifier and a high-precision analog-to-digital converter to ensure accurate signal monitoring and condition detection. The digital components include a microcontroller unit (MCU) and a digital signal processor (DSP) that work in tandem to dynamically manage SCPAC-related data, including configuration matching, logging control, and measurement reporting based on CPAC execution events.

The subsequent CPAC optimization controller 105 selects subsequent CPAC candidate configuration for the execution of subsequent CPAC. The controller utilizes advanced algorithms to evaluate multiple candidate configurations based on predefined criteria such as signal strength, latency, and resource availability. Further, the subsequent CPAC optimization controller 105 identifies that the selected subsequent CPAC candidate configuration is not stored in the SCG variable for storing conditional reconfiguration (SCG VarConditionalReconfig). This identification process involves cross-referencing the candidate configuration with the existing entries in the SCG variable database to ensure no duplication.

Further, the subsequent CPAC optimization controller 105 detects each srb-identity included in the radio bearer configuration that is part of the current UE 101 configuration. The detection mechanism employs a detailed parsing of the radio bearer configuration to extract and verify the srb-identity values.

Further, the subsequent CPAC optimization controller 105 determines whether the radio bearer is the SRB5 when the srb-identity is included in the radio bearer configuration that is part of the current UE 101 configuration. This determination may be made using a lookup table that maps srb-identity values to their corresponding radio bearer types.

Further, the subsequent CPAC optimization controller 105 determines whether the new sk-Counter value is selected due to the conditional reconfiguration execution for subsequent CPAC when the radio bearer is SRB5. The subsequent CPAC optimization controller 105 checks the sk-Counter value against a threshold to decide if a new value needs to be selected.

Further, the subsequent CPAC optimization controller 105 re-establishes the corresponding RLC entity. The re-establishment process may include resetting the RLC entity parameters and reinitializing the communication channels.

Further, when the new sk-Counter value is selected due to the conditional reconfiguration execution for the subsequent CPAC, the subsequent CPAC optimization controller 105 updates the sk-Counter value in the UE's security context to ensure synchronization with the network.

The subsequent CPAC optimization controller 105 configures the PDCP entity to apply an integrity protection configuration and key associated with the secondary key as indicated in keyToUse. The integrity protection configuration involves setting up cryptographic algorithms and key management protocols to secure the data. In addition, the integrity protection configuration is applied to all subsequent messages received and sent by the UE. This ensures that all communication is protected against tampering and unauthorized access. Further, the subsequent CPAC optimization controller 105 configures the PDCP entity to apply the ciphering configuration and key associated with the secondary key as indicated in keyToUse. The ciphering configuration includes selecting encryption algorithms and initializing the ciphering keys. In addition, the ciphering configuration is applied to all subsequent messages received and sent by the UE. This allows for the confidentiality of the data transmitted between the UE and the network.

Further, the subsequent CPAC optimization controller 105 triggers the PDCP entity of the radio bearer to perform PDCP re-establishment. The re-establishment process may include resetting the PDCP state and re-synchronizing the sequence numbers to ensure seamless communication.

When the new sk-Counter value is not selected due to the conditional reconfiguration execution for the subsequent CPAC, the subsequent CPAC optimization controller 105 triggers a PDCP entity of a radio bearer to perform SDU discard. The SDU discard process involves identifying and removing any unacknowledged SDUs from the PDCP buffer to prevent data loss and ensure efficient resource utilization.

Further, the subsequent CPAC optimization controller 105 facilitates logging and reporting of a time elapsed between an initiation of execution of a conditional reconfiguration for a target PSCell and a reception of a last applied conditional reconfiguration for the SCG, wherein the last applied conditional reconfiguration comprises the conditional reconfiguration of the target PSCell. The logging mechanism captures precise timestamps and stores them in a dedicated log file for future analysis. The reporting process involves generating detailed reports that include the time elapsed and other relevant metrics, which are then transmitted to the network apparatus for performance evaluation.

The subsequent CPAC optimization controller 105 determines that a measurement configuration application layer identifier is not included in the reconfiguration applied during execution of the subsequent CPAC. The determination process may include scanning the reconfiguration message for the presence of application layer identifiers and comparing them with the expected list. Upon such determination, the subsequent CPAC optimization controller (105) informs the upper layers about the release of all application layer measurement configurations. The subsequent CPAC optimization controller 105 sends a notification to the upper layers, indicating the release and providing details about the affected configurations. The subsequent CPAC optimization controller 105 releases all such configurations including their corresponding fields in the UE 101 variables when stored. The release process may include clearing the stored variables and freeing up memory resources. The subsequent CPAC optimization controller 105 discards any received application layer measurement reports from the upper layers and configures the UE to consider itself not configured to send application layer measurement reports. The configuration update allows the UE to stop generating and transmitting measurement reports, thereby optimizing resource usage.

Further, the subsequent CPAC optimization controller 105 allows the UE 101 to apply the conditional reconfiguration based on either the complete reconfiguration message included in the candidate configuration or a reference configuration in combination with the non-complete reconfiguration message included in the candidate configuration and the non-complete reconfiguration message in candidate configuration. The subsequent CPAC optimization controller 105 evaluates the completeness of the reconfiguration message and decides whether to use the entire message or combine it with a reference configuration for optimal performance.

Further, the subsequent CPAC optimization controller 105 determines that measurement configuration application layer identifier corresponding to connected mode measurements is not included in the reconfiguration applied during execution of the subsequent CPAC. The determination may include checking the reconfiguration message for the presence of connected mode measurement identifiers.

Further, the subsequent CPAC optimization controller 105 informs upper layers about the release of all application layer measurement configurations. The controller sends a notification to the upper layers, detailing the release and its implications.

The subsequent CPAC optimization controller 105 releases all application layer measurement configurations including their fields in the UE 101 variables, if stored. The release process may include clearing the stored variables and freeing up memory resources.

The subsequent CPAC optimization controller 105 discards any received application layer measurement reports from upper layers. The discard process may include identifying and removing any received reports from the buffer.

The subsequent CPAC optimization controller 105 configures to not send application layer measurement reports. The configuration update allows the UE to stop generating and transmitting measurement reports, thereby optimizing resource usage.

Further, the subsequent CPAC optimization controller 105 determines that all measurement configuration application layer identifiers that are included in the reconfiguration applied during execution of the subsequent CPAC are within an inactive configuration. The determination may include checking the reconfiguration message for the presence of inactive configuration identifiers.

The subsequent CPAC optimization controller 105 informs upper layers about the release of all application layer measurement configurations. The controller sends a notification to the upper layers, detailing the release and its implications.

The subsequent CPAC optimization controller 105 releases all application layer measurement configurations including their fields in the UE 101 variables, if stored. The release process may include clearing the stored variables and freeing up memory resources.

The subsequent CPAC optimization controller 105 discards any received application layer measurement reports from upper layers. The discard process may include identifying and removing any received reports from the buffer.

Further, the subsequent CPAC optimization controller 105 configures to not send application layer measurement reports. The configuration update allows that the UE stops generating and transmitting measurement reports, thereby optimizing resource usage.

The subsequent CPAC optimization controller 105, upon execution of the conditional reconfiguration for subsequent CPAC, identifies any application layer measurement configuration which is part of the UE 101 configuration prior to the execution but not part of the candidate configuration. The identification process may include scanning the UE configuration for measurement identifiers and comparing them with the candidate configuration.

The subsequent CPAC optimization controller 105 forwards the corresponding measurement configuration application layer identifier and informs the upper layers about the release of the respective application layer measurement configuration including any RAN visible application layer measurement configuration. The subsequent CPAC optimization controller 105 sends a notification to the upper layers, detailing the release and its implications. Furthermore, the subsequent CPAC optimization controller 105 discards any application layer measurement reports received from the upper layers, releases the application layer measurement configuration including its fields in the UE 101 variables, if stored, and configures the UE 101 to not send application layer measurement reports corresponding to the identified measurement configuration application layer identifier. The configuration update allows the UE to stop generating and transmitting measurement reports, thereby optimizing resource usage.

Further, the subsequent CPAC optimization controller 105 transmits capability information to a network apparatus wherein the capability information indicates whether the UE 101 is capable of logging and reporting specific-related information for the SON or MDT purposes or whether the UE 101 supports specific-related optimizations including mobility robustness optimization (MRO). The capability information includes detailed metrics and parameters that describe the UE's logging and reporting capabilities, as well as its support for specific optimizations.

Further, the subsequent CPAC optimization controller 105 transmits capability information to a network apparatus, wherein the capability information indicates per-UE capability without differentiation based on duplex or frequency range. The capability information includes detailed metrics and parameters that describe the UE's capabilities across different duplex modes and frequency ranges, ensuring comprehensive coverage.

Further, the subsequent CPAC optimization controller 105 performs PDCP re-establishment. The re-establishment may include triggering a PDCP entity associated with SRB5 to perform a re-establishment procedure. The procedure may include resetting the PDCP state, re-synchronizing sequence numbers, and reinitializing security contexts to ensure seamless communication.

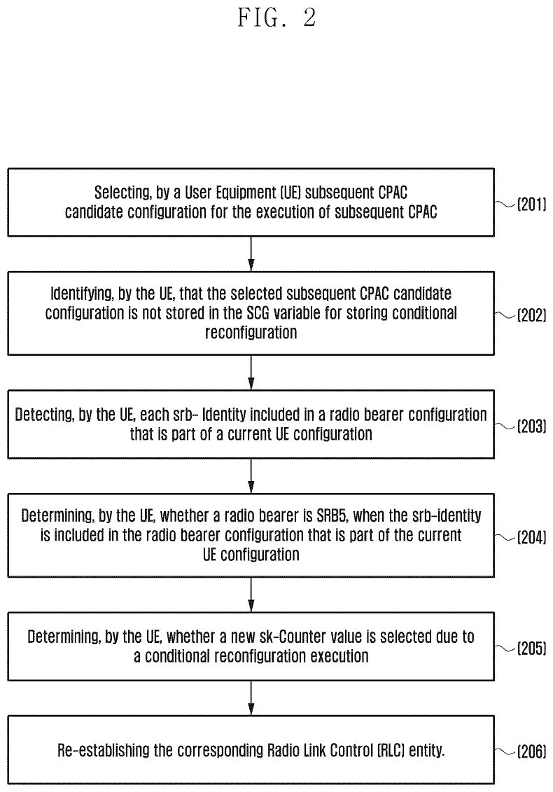

FIG. 2 is a flowchart illustrating a method for handling subsequent CPAC in a communication network system according to an embodiment.

Referring to FIG. 2, at step 201, a subsequent CPAC candidate configuration is selected for execution. For example, a UE identifies a suitable configuration from a set of available candidates based on measurements performed and predefined criteria relevant for conditional reconfiguration received from a network.

At step 202, the UE identifies that the selected subsequent CPAC candidate configuration is not stored in an SCG variable for conditional reconfiguration (SCG VarConditionalReconfig). This allows for the configuration to be received with the involvement of an MN, and to include proper parameters (e.g., related to security).

At step 203, the UE detects each SRB identity included in the radio bearer configuration that is part of the current UE configuration. For example, the detection includes parsing the active configuration to extract identifiers of the SRBs, including SRB5, for further evaluation.

At step 204, the UE determines whether a radio bearer is the SRB5 when the detected SRB identity is present in the radio bearer configuration. This step differentiates SRB5 from other SRBs, such as SRB1 or SRB2, to apply SRB-specific logic and security handling. Applying SCPAC specific logic and security handling during SCPAC may be restricted to specific SRBs to ensure that the security operations and data handling of SRBs in the master node are not affected.

At step 205, the UE determines whether the new sk-Counter value is selected due to the execution of the conditional reconfiguration for the subsequent CPAC, when the identified radio bearer is SRB5. The selection of the new sk-Counter value allows the secure communication to continue after the conditional event, especially for Inter-SN mobility.

At step 206, the corresponding RLC entity associated with the identified SRB5 is re-established. The re-establishment allows the UE to maintain protocol integrity and reliable data transmission after reconfiguration.

In an embodiment, a UE that supports the MRO for the subsequent CPAC reports the neighboring cell as the candidate PSCell only if the neighboring cell has execution conditions configured. In the case of subsequent CPAC, the UE may be configured with conditional RRCReconfiguration information, such as condRRCReconfig, without an associated execution condition, and such neighboring cells are not reported as candidate PSCells. The UE that does not support the MRO for the subsequent CPAC may log and report a neighboring cell as the candidate PSCell if an associated conditional RRCReconfiguration, such as condRRCReconfig, is present even in the absence of an associated execution condition.

In an embodiment, the UE avoids logging and reporting the time since the last CPAC reconfiguration, such as the timeSinceCPAC-Reconfig parameter defined in the NR, when the last received CPAC configuration corresponds to a subsequent CPAC procedure.

In an embodiment, the UE avoids logging and reporting the time since the last CPAC reconfiguration, such as timeSinceCPAC-Reconfig in the NR, if the applied CPAC configuration is associated with the subsequent CPAC execution.

In an embodiment, the UE avoids logging and reporting the time since the last CPAC reconfiguration, such as timeSinceCPAC-Reconfig in the NR, if the applied CPAC reconfiguration corresponds to the subsequent CPAC and the CPAC reconfiguration was not received while the UE was connected to the current source PSCell.

In an embodiment, the UE avoids logging and reporting the time since the last CPAC reconfiguration, such as timeSinceCPAC-Reconfig in the NR, if the applied CPAC reconfiguration corresponds to a subsequent CPAC and the CPAC reconfiguration was not received while the UE was connected to the current source PSCell prior to any PSCell change toward the source PSCell.

In an embodiment, the network identifies the CPAC as a subsequent CPAC based on the absence of the timeSinceCPAC-Reconfig parameter.

In an embodiment, the UE supporting the MRO for the subsequent CPAC avoids logging and reporting the time since the last CPAC reconfiguration, such as timeSinceCPAC-Reconfig in the NR, if the last received CPAC configuration corresponds to the subsequent CPAC.

In yet an embodiment, the UE supporting the MRO for the subsequent CPAC avoids logging and reporting the time since the last CPAC reconfiguration, such as timeSinceCPAC-Reconfig in the NR, if the applied CPAC configuration corresponds to the subsequent CPAC.

In an embodiment, the UE supporting the MRO of the subsequent CPAC avoids logging and reporting the time since the last CPAC reconfiguration, such as time SinceCPAC-Reconfig in the NR, if the applied CPAC reconfiguration corresponds to the subsequent CPAC and the CPAC reconfiguration is not received while the UE was connected to the current source PSCell.

In an embodiment, the UE supporting the MRO of the subsequent CPAC avoids logging and reporting the time since the last CPAC reconfiguration, such as timeSinceCPAC-Reconfig in the NR, if the applied CPAC reconfiguration corresponds to the subsequent CPAC and the CPAC reconfiguration is not received while the UE is connected to the current source PSCell prior to any PSCell change toward the source PSCell.

In an embodiment, the UE may receive multiple conditional reconfiguration messages for the CPAC, for example, one conditional reconfiguration for CHO with the SCG activation, one for normal CPAC, and one for the SCPAC.

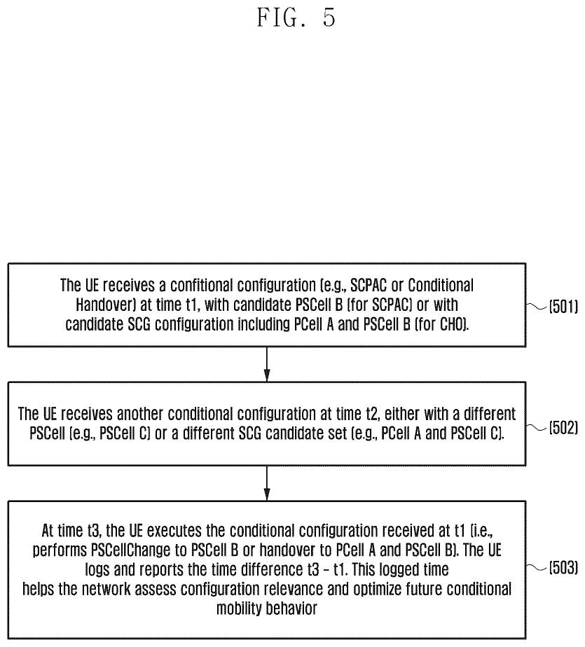

In an embodiment, the UE may log and report the timeSinceCPAC-Reconfig as the time elapsed between the initiation of the execution of the conditional reconfiguration for the target PSCell and the reception of the last applied conditionalReconfiguration for the SCG, including the condRRCReconfig of the target PSCell. An embodiment related to the UE operation of storing and reporting the timeSinceCPAC-Reconfig will be described in more detail later with reference to FIG. 5.

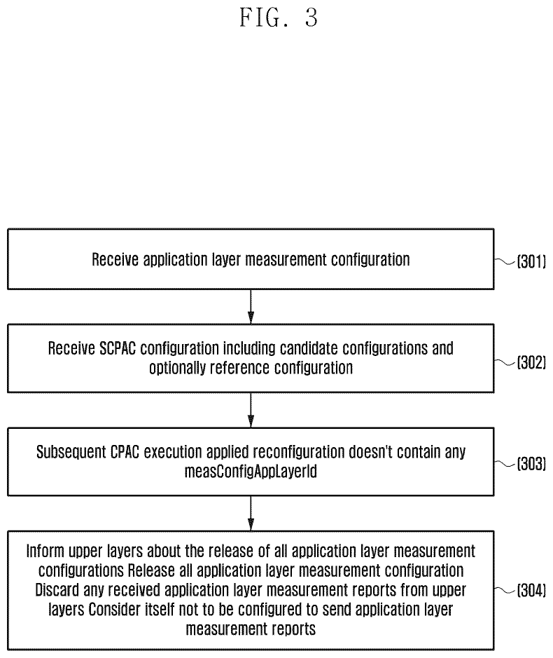

FIG. 3 is a flowchart illustrating a scenario of a UE RRC handling application layer measurement configuration, according to an embodiment.

Referring to FIG. 3, at step 301, the UE receives one or more application layer measurement configurations.

At step 302, the UE receives SCPAC configuration information including one or more candidate configurations and optionally a reference configuration.

At step 303, the SCPAC execution is triggered, and the applied RRCReconfiguration does not contain any measConfigAppLayerId.

At step 304, the UE RRC informs the upper layers about the release of all application layer measurement configurations, releases all application layer measurement configurations, including any stored fields such as VarAppLayerIdleConfig and VarAppLayerPLMN-ListConfig if present, discards any received application layer measurement reports from the upper layers, and considers itself not configured to send application layer measurement reports.

In an embodiment according to TS 38.331:
2> store the successful PSCell change or addition information in VarSuccessPSCell-Report and determine the content in VarSuccessPSCell-Report as follows:
3> for the target PSCell indicated in the last applied RRCReconfiguration message for the SCG, including reconfiguration WithSync:
4> if the last applied RRCReconfiguration message for the SCG, including reconfigurationWithSync, was included in the stored condRRCReconfig:
5> set the timeSinceCPAC-Reconfig to the time elapsed between the initiation of the execution of conditional reconfiguration for the target PSCell and the reception of the last applied conditionalReconfiguration for the SCG, including the condRRCReconfig of the target PSCell.

In an embodiment, the UE may log and report the identifier of the cell, such as a physical cell identity (PCI), an NR absolute RF channel number (NR-ARFCN), or cell global identity (CGI), from which the UE received the last conditionalReconfiguration for the SCG, including the condRRCReconfig of the target PSCell.

In an embodiment, such logging and reporting may be performed if the UE supports the MRO for the CPAC.

In an embodiment, the UE may log and report the identifier of the cell, such as PCI, NR-ARFCN, or CGI, from which the UE received the last applied conditionalReconfiguration for the SCG, including the condRRCReconfig of the target PSCell. This reporting may also be performed if the UE supports MRO of subsequent CPAC.

In an embodiment, the UE may log and report the identifier of the cell, such as PCI, NR-ARFCN, or CGI, from which the UE received the last applied conditional Reconfiguration for the SCG, including the condRRCReconfig of the target PSCell. This reporting may also be performed if the UE supports MRO of subsequent CPAC.

In an embodiment, an NR UE sets a firstTriggeredEvent and/or timeBetweenEvents in the NR or the first triggered event and the time between CPAC events for other wireless technologies, if any of condExecutionCond, condExecutionCondSCG, subsequentCondExecutionCond, or subsequentCondExecutionCondSCG is available.

In an embodiment, upon execution of a subsequent CPAC, when a measurement configuration application layer identifier (measConfigAppLayerId) is not included in the RRC reconfiguration applied during such execution, the UE performs one or more of the following:
(a) the UE RRC informs upper layers regarding the release of all application layer measurement configurations,
(b) the UE RRC releases all application layer measurement configurations, including any corresponding fields stored in the UE variables such as VarAppLayerIdleConfig and VarAppLayerPLMN-ListConfig, if present,
(c) the UE RRC discards any application layer measurement reports received from the upper layers, and
(d) the UE RRC considers itself not configured to send application layer measurement reports.

In an embodiment, the UE applies the RRC Reconfiguration message either based on a complete RRCReconfiguration message in the SCPAC candidate configuration or based on a reference configuration and a non-complete RRCReconfiguration message in the SCPAC candidate configuration.

In an embodiment, upon execution of the SCPAC, when the measurement configuration application layer identifier (measConfigAppLayerId) corresponding to RRC_CONNECTED mode measurements is not included in the RRC reconfiguration applied during the SCPAC execution, the UE performs one or more of the following steps:
(a) the UE RRC informs upper layers about the release of all application layer measurement configurations,
(b) the UE releases all application layer measurement configurations, including their fields in the UE variables VarAppLayerIdleConfig and VarAppLayerPLMN-ListConfig, if stored,
(c) the UE discards any received application layer measurement reports from the upper layers, and
(d) the UE considers itself not to be configured to send application layer measurement reports.

In an embodiment, upon execution of the SCPAC, when all measurement configuration application layer identifiers (measConfigAppLayerId) included in the RRC reconfiguration applied during the SCPAC execution are within the appLayerIdleInactiveConfig, the UE performs one or more of the following actions:
(a) the UE RRC informs upper layers about the release of all application layer measurement configurations,
(b) the UE releases all application layer measurement configurations, including their fields in the UE variables VarAppLayerIdleConfig and VarAppLayerPLMN-ListConfig, if stored,
(c) the UE discards any received application layer measurement reports from the upper layers, and
(d) the UE considers itself not to be configured to send application layer measurement reports.

This method allows including the application layer measurement configuration in a group of PSCells, where some of the PSCells support the application layer measurements and some of the PSCells do not support the application layer measurements. When the UE moves from a PSCell that supports application layer measurements to another PSCell that does not support application layer measurements, the configuration is seamlessly released by this method, without any involvement of the target SN node which does not support application layer measurements. This also prevents the UE from performing or storing these measurements when the network is not able to process these measurement.

In an embodiment, upon execution of the SCPAC for any application layer measurement configuration that is part of the UE configuration prior to the SCPAC execution, but not included in the SCPAC candidate configuration, either as indicated by lower layers or for the selected cell in accordance with Section 5.3.7.3 or in the SCPAC reference configuration (in cases where the SCPAC candidate configuration does not include scpac-ConfigComplete), the UE performs one or more of the following steps:
(a) the UE RRC forwards the measConfigAppLayerId and informs upper layers about the release of the application layer measurement configuration, including any RAN visible application layer measurement configuration,
(b) the UE discards any application layer measurement reports received from the upper layers,
(c) the UE releases the application layer measurement configuration, including its fields in the UE variables VarAppLayerIdleConfig and VarAppLayerPLMN-ListConfig if stored, and
(d) the UE considers itself not to be configured to send application layer measurement reports for the measConfigAppLayerId.

This method allows including the application layer measurement configuration in a group of PSCells, where some of the PSCells support some of the application layer measurements and some of the PSCells do not support the application layer measurements. When the UE moves from a PSCell that supports some application layer measurements to another PSCell that does not support some of these application layer measurements, the unsupported configuration is seamlessly released by this method, without any involvement of the target SN node which does not support application layer measurements. This also prevents the UE from performing or storing these measurements when the network is not able to process these measurements.

In an embodiment, the UE informs the network whether the UE is capable of logging and reporting SCPAC-related information for SON or MDT purposes or whether it supports SCPAC-related optimizations such as MRO.

In an embodiment, in NR, the capability for the SCPAC-related logging, reporting, and optimization support is conveyed by the UE to the network via the UECapability Information message. This SCPAC-related capability is defined as a per-UE capability, is optional, and is not distinguished based on duplexing mode (e.g., frequency division duplexing (FDD) or time division duplexing (TDD)) or operating frequency range (frequency range 1 (FR-1) or frequency range 2 (FR-2)).

In an embodiment, the network does not indicate to the UE 01 whether the network is capable of logging and reporting SCPAC-related information or whether the network supports SCPAC-related optimization for SON or MDT purposes. However, the UE may determine its behavior based on whether the UE supports SCPAC-related information logging and reporting functionalities.

In an embodiment, according to TS 38.331, while reporting SCGFailureInformation for each MeasObjectNR configured by a MeasConfig associated with the MCG and for which measurement results are available:
2> set the measResultNeighCellList in measResultFreqList to include the best measured cells ordered such that the best cell is listed first and based on measurements collected up to the moment the UE detected the failure and set its fields as follows:
3> ordering the cells with sorting as follows:
4> based on SS/PBCH block if SS/PBCH block measurement results are available and otherwise based on CSI-RS:
4> using RSRP if RSRP measurement results are available, otherwise using RSRQ if RSRQ measurement results are available, otherwise using SINR:
   3> if the UE supports SCG failure information for mobility robustness optimization for conditional PSCell change or addition for each neighbour cell, if any, included in measResultListNR in measResultFreqList:
   4> if the neighbour cell is one of the candidate cells for which the reconfigurationWithSync is included in the secondaryCellGroup in the MCG VarConditionalReconfig (for CPA or inter-SN CPC in NR-DC) or SCG VarConditionalReconfig (for intra-SN CPC) at the moment of the detected SCG failure (radio link failure at PSCell or PSCell change or addition failure):
   5> if the first entry of condExecutionCond or condExecutionCondSCG associated to the neighbour cell, if available, corresponds to a fulfilled execution condition at the moment of SCG failure or:
   5> if the second entry of condExecutionCond or condExecutionCondSCG associated to the neighbour cell, if available, corresponds to a fulfilled execution condition at the moment of SCG failure:
   6> set firstTriggeredEvent to the execution condition condFirstEvent corresponding to the first entry of condExecutionCond or condExecutionCondSCG associated to the neighbour cell or to the execution condition condSecondEvent corresponding to the second entry of condExecutionCond or condExecutionCondSCG associated to the neighbour cell, whichever execution condition was fulfilled first in time:
   6> set timeBetweenEvents to the elapsed time between the point in time of fulfilling the condition in condExecutionCond or condExecutionCondSCG associated to the neighbour cell that was fulfilled first in time and the point in time of fulfilling the condition in condExecutionCond or condExecutionCondSCG associated to the neighbour cell that was fulfilled second in time if both the first execution condition corresponding to the first entry and the second execution condition corresponding to the second entry in the condExecutionCond or condExecutionCondSCG associated to the neighbour cell were fulfilled.

In an embodiment according to TS 38.331, while reporting SCGFailureInformation for each MeasObjectNR configured by a MeasConfig associated with the MCG and for which measurement results are available:
2> set the measResultNeighCellList in measResultFreqList to include the best measured cells ordered such that the best cell is listed first and based on measurements collected up to the moment the UE detected the failure and set its fields as follows:
3> ordering the cells with sorting as follows:
4> based on SS/PBCH block if SS/PBCH block measurement results are available and otherwise based on CSI-RS:
4> using RSRP if RSRP measurement results are available, otherwise using RSRQ if RSRQ measurement results are available, otherwise using SINR:
3> if the UE supports SCG failure information for mobility robustness optimization for conditional PSCell change or addition for each neighbour cell, if any, included in measResultListNR in measResultFreqList:
4> if the neighbour cell is one of the candidate cells for which the reconfigurationWithSync is included in the secondaryCellGroup in the MCG VarConditionalReconfig (for CPA or inter-SN CPC in NR-DC) or SCG VarConditionalReconfig (for intra-SN CPC) at the moment of the detected SCG failure (radio link failure at PSCell or PSCell change or addition failure):
5> if the first entry of condExecutionCond or condExecutionCondSCG or subsequentCondExecutionCond or subsequentCondExecutionCondSCG associated to the neighbour cell, if available, corresponds to a fulfilled execution condition at the moment of SCG failure or:
5> if the second entry of condExecutionCond or condExecutionCondSCG or subsequentCondExecutionCond or subsequentCondExecutionCondSCG associated to the neighbour cell, if available, corresponds to a fulfilled execution condition at the moment of SCG failure:
6> set firstTriggeredEvent to the execution condition condFirstEvent corresponding or condExecutionCondSCG or to the first entry of condExecutionCond subsequentCondExecutionCond or subsequentCondExecutionCondSCG associated to the neighbour cell or to the execution condition condSecondEvent corresponding to the second entry of condExecutionCond or condExecutionCondSCG or subsequentCondExecutionCond or subsequentCondExecutionCondSCG associated to the neighbour cell, whichever execution condition was fulfilled first in time:
6> set timeBetweenEvents to the elapsed time between the point in time of fulfilling the condition in condExecutionCond or condExecutionCondSCG or subsequentCondExecutionCond or subsequentCondExecutionCondSCG associated to the neighbour cell that was fulfilled first in time and the point in time of fulfilling the condition in condExecutionCond or condExecutionCondSCG or subsequentCondExecutionCond or subsequentCondExecutionCondSCG associated to the neighbour cell that was fulfilled second in time if both the first execution condition corresponding to the first entry and the second execution condition corresponding to the second entry in the condExecutionCond or condExecutionCondSCG or subsequentCondExecutionCond or subsequentCondExecutionCondSCG associated to the neighbour cell were fulfilled.

In an embodiment, if the new sk-Counter value has been selected due to the conditional reconfiguration execution for the subsequent CPAC and the SRB5 is for the SRB5 and apply integrity/ciphering based on the new KRRCint key or new KRRCenc key.

In an embodiment, if the new sk Counter value has not been selected due to the conditional reconfiguration execution for the subsequent CPAC and SRB5 is part of the current UE configuration, the UE PDCP associated to the SRB5 triggers the PDCP discard.

In an embodiment, this is applied if the SCPAC execution is for the SCPAC configuration stored in the SCG VarConditionalReconfig.

In an embodiment, this is not applied if the SCPAC execution is for the SCPAC configuration stored in MCG VarConditionalReconfig part of the current UE configuration, the UE performs PDCP reestablishment.

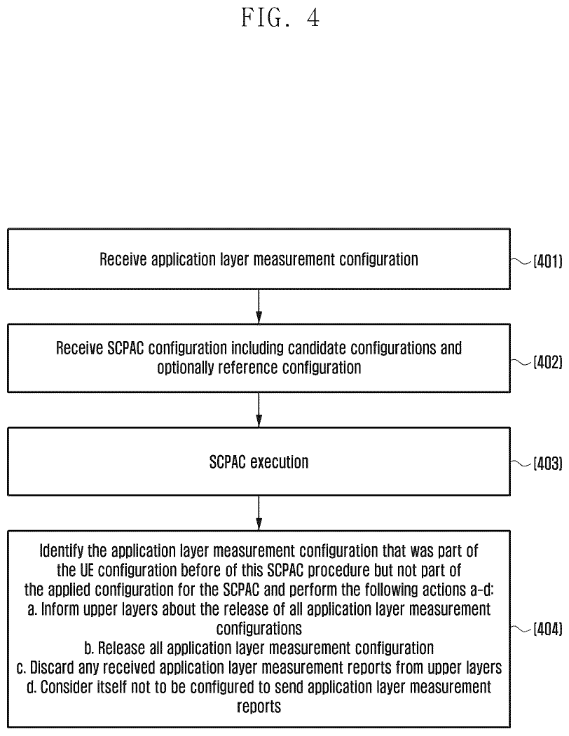

FIG. 4 is a flowchart illustrating a scenario of a UE RRC handling application layer measurement configuration according to an embodiment.

Referring to FIG. 4, at step 401, the UE receives one or more application layer measurement configurations.

At step 402, the UE receives the SCPAC configuration information including one or more candidate configurations and optionally a reference configuration.

At step 403, the UE performs the SCPAC execution.

At step 404, the UE identifies one or more application layer measurement configurations that were part of the UE configuration prior to the SCPAC execution, but are not part of the applied configuration for the SCPAC. The UE then performs one or more of the following steps:
a) inform the upper layers about the release of all application layer measurement configurations,
b) release all application layer measurement configurations, including their fields in relevant UE variables,
c) discard any received application layer measurement reports from upper layers, and
d) consider itself not to be configured to send application layer measurement reports.

In an embodiment according to TS 38.331, while reporting SCGFailureInformation for each MeasObjectNR configured by a MeasConfig associated with the MCG and for which measurement results are available,
2> set the measResultNeighCellList in measResultFreqList to include the best measured cells ordered such that the best cell is listed first and based on measurements collected up to the moment the UE detected the failure and set its fields as follows:
3> ordering the cells with sorting as follows, 4> based on SS/PBCH block if SS/PBCH block measurement results are available and otherwise based on CSI-RS,
4> using RSRP if RSRP measurement results are available otherwise using RSRQ if RSRQ measurement results are available otherwise using SINR,
3> if the UE supports SCG failure information for mobility robustness optimization for conditional PSCell change or addition for each neighbor cell if any included in measResultListNR in measResultFreqList,
4> if the neighbor cell is one of the candidate cells for which the reconfigurationWithSync is included in the secondaryCellGroup in the MCG VarConditionalReconfig (for CPA or inter-SN CPC in NR-DC) or SCG VarConditionalReconfig (for intra-SN CPC) at the moment of the detected SCG failure (radio link failure at PSCell or PSCell change or addition failure),
5> if the first entry of condExecutionCond or condExecutionCondSCG or subsequentCondExecutionCond or subsequentCondExecutionCondSCG associated to the neighbor cell if available corresponds to a fulfilled execution condition at the moment of SCG failure or,
5> if the second entry of condExecutionCond or condExecutionCondSCG or subsequentCondExecutionCond or subsequentCondExecutionCondSCG associated to the neighbor cell if available corresponds to a fulfilled execution condition at the moment of SCG failure,
6> set firstTriggeredEvent to the execution condition condFirstEvent corresponding to the first entry of condExecutionCond or condExecutionCondSCG or subsequentCondExecutionCond or subsequentCondExecutionCondSCG associated to the neighbor cell or to the execution condition condSecondEvent corresponding to the second entry of condExecutionCond or condExecutionCondSCG or subsequentCondExecutionCond or subsequentCondExecutionCondSCG associated to the neighbor cell whichever execution condition was fulfilled first in time,
6> set timeBetweenEvents to the elapsed time between the point in time of fulfilling the condition in condExecutionCond or condExecutionCondSCG or subsequentCondExecutionCond or subsequentCondExecutionCondSCG associated to the neighbor cell that was fulfilled first in time and the point in time of fulfilling the condition in condExecutionCond or condExecutionCondSCG or subsequentCondExecutionCond or subsequentCondExecutionCondSCG associated to the neighbor cell that was fulfilled second in time if both the first execution condition corresponding to the first entry and the second execution condition corresponding to the second entry in the condExecutionCond or condExecutionCondSCG or subsequentCondExecutionCond or subsequentCondExecutionCondSCG associated to the neighbor cell were fulfilled.

In an embodiment, if the new sk-Counter value is selected as a result of the conditional reconfiguration execution for the SCPAC and the SRB5 is part of the current UE configuration, the UE performs the PDCP reestablishment for SRB5 and applies integrity protection and ciphering based on the newly selected KRRCint key or KRRCenc key.

In an embodiment, this behavior is applicable only for SCPAC configurations stored in the SCG variable VarConditionalReconfig.

In an embodiment, according to TS 38.331, 5.3.5.13.8 Subsequent CPAC execution, upon the conditional reconfiguration execution for subsequent CPAC, the UE shall:
1> if the selected subsequent CPAC candidate configuration is stored in the SCG VarConditionalReconfig:
   <some actions>
else:
<some actions>
2> for each srb-Identity included in RadioBearerConfig that is part of the current UE configuration and if the radio bearer is SRB5, the UE shall perform the following actions after the end of this procedure:
3> if a new sk-Counter value has been selected due to the conditional reconfiguration execution for subsequent CPAC:
4> configure the PDCP entity to apply the integrity protection algorithm and KRRCint key associated with the secondary key (S-KgNB) as indicated in keyToUse, i.e., the integrity protection configuration shall be applied to all subsequent messages received and sent by the UE, including the message used to indicate the successful completion of the procedure;
4> configure the PDCP entity to apply the ciphering algorithm and KRRCenc key associated with the secondary key (S-KgNB) as indicated in keyToUse, i.e., the ciphering configuration shall be applied to all subsequent messages received and sent by the UE, including the message used to indicate the successful completion of the procedure;
4> trigger the PDCP entity of SRB to perform PDCP re-establishment as specified in TS 38.323;
3> else:
4> trigger the PDCP entity of SRB to perform SDU discard as specified in TS 38.323;
re-establish the corresponding RLC entity as specified in TS 38.322;

In an embodiment, upon execution of the conditional reconfiguration for the SCPAC, for each radio bearer and the associated logical channel that is part of the current UE configuration, but is not included in the subsequent CPAC candidate configuration for the selected cell, or in the subsequent CPAC reference configuration (in cases where the candidate configuration does not include scpac-ConfigComplete), the UE performs the following actions:
a). release the PDCP entity and the corresponding drb-Identity of a data radio bearer (DRB);
b). if a service data adaptation protocol (SDAP) entity associated with the DRB is configured, the UE RRC indicates the release of the DRB to the associated SDAP entity, and the SDAP entity is subsequently released.

In an embodiment, according to TS 38.331, 5.3.5.13.8, subsequent CPAC execution, upon the conditional reconfiguration execution for subsequent CPAC, the UE shall:
release the radio bearer(s) according to section 5.3.5.6.4 (for DRBs) and 5.3.5.6.2 (for DRBs) and the associated logical channel(s) that are part of the current UE configuration, but not part of the subsequent CPAC candidate configuration for the selected cell, or the subsequent CPAC reference configuration (in case the subsequent CPAC candidate configuration does not include scpac-ConfigComplete)

### 5.3.5.6.4 DRB Release

The UE shall:
1> for each drb-Identity value included in the drb-ToReleaseList that is part of the current UE configuration; or
for each drb-Identity value that is to be released as the result of full configuration according to 5.3.5.11; or
for each drb-Identity value that is to be released as the result of subsequent CPAC execution according to 5.3.5.13.8; or
2> release the PDCP entity and the drb-Identity;
2> if SDAP entity associated with this DRB is configured:
3> indicate the release of the DRB to SDAP entity associated with this DRB (TS 37.324, clause 5.3.3);
2> if the DRB is associated with an eps-BearerIdentity:
3> if a new bearer is not added either with NR or E-UTRA with same eps-BearerIdentity:
4> indicate the release of the DRB and the eps-BearerIdentity of the released DRB to upper layers.

Subsequent CPAC is standardized in R18, and the SON/MDT for subsequent CPAC is being standardized in R19, which may get extended to Rel-20.

Without a method as described in the present disclosure, the network cannot configure SRB5 along with SCPAC. Thus, QoE measurements over SN are not possible when SCPAC is configured. Subsequent CPAC introduces new behavior for UE reporting in the SON/MDT, as the configuration is stored in the UE even before the UE moves to the PSCell. The present disclosure provides various schemes handling the same.

More specifically, the disclosure provides efficient handling of subsequent CPAC procedures in a communication network system. Secure and reliable execution of these procedures is ensured by preserving the integrity and ciphering configurations of SRBs. Additionally, the disclosure optimizes the protocol entity behavior during conditional reconfiguration events, particularly by supporting automatic re-establishment of PDCP and RLC entities when security keys are updated. Effective management of application layer measurement configurations is facilitated, ensuring the timely release or suppression of outdated reporting mechanisms during the CPAC execution.

FIG. 5 is a flowchart illustrating an example scenario in which a UE logs and reports a time difference between successive conditional configuration updates and their actual execution, for the purpose of mobility optimization, according to an embodiment.

Referring to FIG. 5, at step 501, the UE receives a conditional configuration (e.g., SCPAC or CHO) at time t1, with candidate PSCell B (for SCPAC) or with candidate SCG configuration including PCell A and PSCell B (for CHO).

At step 502, the UE receives another conditional configuration at time t2; either with a different PSCell (e.g., PSCell C) or a different SCG candidate set (e.g., PCell A and PSCell C)

At step 503, at time t3, the UE executes the conditional configuration received at t1 (i.e., performs PSCellChange to PSCell B or handover to PCell A and PSCell B). The UE logs and reports the time difference t3−t1, indicating the duration between the initiation of the execution of conditional reconfiguration and the reception of the last applied conditional reconfiguration. This logged time helps the network assess configuration relevance and optimize future conditional mobility behavior.

In an embodiment, e.g., after a UE is configured with SCPAC configuration with PSCell B at t1, it is again configured with SCPAC configuration for PSCell C at t2. At t3, if the UE performs PSCellChange to PSCell B; i.e., based on the configuration received at t1, the UE logs and reports the time t3−t1. This allows the network to receive the time information about the configuration of the executed mobility procedure and adjust the configuration for optimization of the mobility.

For example, after a UE is configured for CHO with candidate SCG configuration with Pcell A and PSCell B at t1, it is again configured for CHO with candidate SCG PCell A and PSCell C at t2. At t3, if the UE performs handover to Pcell A and PSCell B, i.e., based on the configuration received at t1, the UE logs and reports the time t3−t1. This allows the network to receive the time information about the configuration of the executed mobility procedure and adjust the configuration for optimization of the mobility.

In an embodiment, this logging and reporting behavior may be applicable when the UE supports MRO for subsequent CPAC.

In an embodiment, logging and reporting behavior may be applicable when the UE supports MRO for CHO with candidate SCG.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. The phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a wireless communication system, the method comprising:
receiving, from a base station, a first radio resource control (RRC) reconfiguration message including at least one candidate configuration for a subsequent conditional primary secondary cell (PSCell) addition or change (CPAC);
storing the at least one candidate configuration for the subsequent CPAC;
selecting a configuration from the at least one candidate configuration for the subsequent CPAC for an execution of the subsequent CPAC, the configuration being not stored in a secondary cell group (SCG) variable for storing conditional reconfiguration;
determining whether a radio bearer configured in the terminal is a signaling radio bearer (SRB) 5 and an sk-counter value is updated due to the execution of the subsequent CPAC; and
in case that the radio bearer is the SRB 5 and the sk-counter value is updated due to the execution of the subsequent CPAC, triggering a packet data convergence protocol (PDCP) entity of the SRB 5 to perform a PDCP re-establishment.

2. The method of claim 1, wherein the at least one candidate configuration for the subsequent CPAC is stored in a master cell group (MCG) variable for storing conditional reconfiguration or the SCG variable.

3. The method of claim 1, wherein information on a radio bearer configuration is configured in the terminal, and
wherein an SRB-identity corresponding to the SRB 5 is included in the information on the radio bearer configuration.

4. The method of claim 1, further comprising:
configuring the PDCP entity to apply an algorithm for integrity protection and a first security key for integrity protection of an RRC signaling;
configuring the PDCP entity to apply an algorithm for ciphering and a second security key for ciphering of the RRC signaling; and
re-establishing a radio link control (RLC) entity associated with the SRB 5,
wherein the first security key and the second security key are associated with a secondary key.

5. The method of claim 1, further comprising, in case that the radio bearer is the SRB 5 and the sk-counter value is not updated, triggering the PDCP entity of the SRB 5 to perform a service data unit (SDU) discard.

6. The method of claim 1, further comprising transmitting, to the base station, a report on a quality of experience (QoE) measurement based on the SRB 5.

7. The method of claim 1, further comprising applying a second RRC reconfiguration message included in the configuration.

8. A terminal in a wireless communication system, the terminal comprising:
a transceiver;
a processor communicatively coupled to the transceiver; and
memory, communicatively coupled to the processor, storing instructions executable by the processor to cause the terminal to:
receive, from a base station, a first radio resource control (RRC) reconfiguration message including at least one candidate configuration for a subsequent conditional primary secondary cell (PSCell) addition or change (CPAC),
store the at least one candidate configuration for the subsequent CPAC,
select a configuration from the at least one candidate configuration for the subsequent CPAC for an execution of the subsequent CPAC, the configuration being not stored in a secondary cell group (SCG) variable for storing conditional reconfiguration,
determine whether a radio bearer configured in the terminal is a signaling radio bearer (SRB) 5 and an sk-counter value is updated due to the execution of the subsequent CPAC, and
in case that the radio bearer is the SRB 5 and the sk-counter value is updated due to the execution of the subsequent CPAC, trigger a packet data convergence protocol (PDCP) entity of the SRB 5 to perform a PDCP re-establishment.

9. The terminal of claim 8,
wherein the at least one candidate configuration for the subsequent CPAC is stored in a master cell group (MCG) variable for storing conditional reconfiguration or the SCG variable.

10. The terminal of claim 8, wherein information on a radio bearer configuration is configured in the terminal, and
wherein an SRB-identity corresponding to the SRB 5 is included in the information on the radio bearer configuration.

11. The terminal of claim 8, wherein the instructions executable by the processor further cause the terminal to:
configure the PDCP entity to apply an algorithm for integrity protection and a first security key for integrity protection of an RRC signaling,
configure the PDCP entity to apply an algorithm for ciphering and a second security key for ciphering of the RRC signaling, and
re-establish a radio link control (RLC) entity associated with the SRB 5, and
wherein the first security key and the second security key are associated with a secondary key.

12. The terminal of claim 8, wherein, in case that the radio bearer is the SRB 5 and the sk-counter value is not updated, the instructions executable by the processor further cause the terminal to trigger the PDCP entity of the SRB 5 to perform a service data unit (SDU) discard.

13. The terminal of claim 8, wherein the instructions executable by the processor further cause the terminal to transmit, to the base station, a report on a quality of experience (QoE) measurement based on the SRB 5.

14. The terminal of claim 8, wherein the instructions executable by the processor further cause the terminal to apply a second RRC reconfiguration message included in the configuration.
